(19) United States
(12) Patent Application Publication
(10) Pub. No.: US 2005/0273530 A1
(43) Pub. Date: Dec. 8, 2005

(54) COMBINED OPTICAL STORAGE AND FLASH CARD READER APPARATUS USING SATA PORT AND ACCESSING METHOD THEREOF

(76) Inventor: Pao-Ching Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/709,939

(22) Filed: Jun. 8, 2004

(51) Int. Cl. G06F 13/12

(52) U.S. Cl. 710/62

(57) ABSTRACT

An electronic apparatus includes a controller having a serial AT Attachment (SATA) port. The controller is electrically coupled to a host through the SATA port. A plurality of peripheral devices are electrically coupled to the controller using digital means. The controller operates as a port multiplier to allow the host to access the peripheral devices through the SATA port. By using the digital means to connect the controller and the attached peripheral devices, no SATA ports or SATA cables are required and the cost of the electronic apparatus is therefore significantly reduced. The reduced number of SATA cables improves air movement and heat dissipation. The digital means can be designed to avoid complicated handshake operations between the controller and the peripheral devices, which improves latency and further increases the efficiency of the electronic apparatus.

### BACKGROUND OF INVENTION

1. Field of the Invention

The invention relates to an electronic information storage and retrieval apparatus, and more particularly, to a combined optical storage and flash card reader apparatus accessible using a Serial AT Attachment (SATA) port.

2. Description of the Prior Art

In today's information oriented society, electronic information accessing devices are increasingly playing a crucial role both in business applications and in the home. In particular, personal computers (PCs), optical storage media, and flash card devices are now well-accepted and important technologies. In order to combine the functions and advantages of these three technologies, interconnect buses such as the Integrated Drive Electronics (IDE) bus, also known as the AT Attachment (ATA) bus and the Parallel AT Attachment (PATA) bus, as well as the Serial AT Attachment (SATA) interface which transfers information serially instead of in parallel, are now in wide use. Because SATA features smaller cable sizes with reduced pin counts and increased throughput speeds, the number of available SATA based products is continuously increasing and SATA is rapidly replacing ATA as the leading interconnect bus. Further information regarding the SATA specification can be found in “Serial ATA: High speed serialized AT attachment”, Rev 1.0a, 2 Jan. 2003; and “Serial ATA II: Extensions to Serial ATA 1.0a”, Rev 1.1, 9 Oct. 2003. Both documents are available on the Serial ATA working group website: www.serialata.org.

FIG. 1 is a block diagram of a first SATA architecture 100 having a single peripheral device 104 according to the prior art. The first SATA architecture 100 includes the peripheral device 104 electrically connected to a host 102 using a SATA cable 116. The host 102 could be a personal computer system, a central processing unit (CPU) of an embedded system, or another device that needs to access the peripheral device 104 and includes a SATA port 118. In the first SATA architecture 100 shown in FIG. 1, the peripheral device 104 is an optical storage device and includes a controller 108, buffer memory 114, an optical storage medium 112, and an optical pick-up 110. In FIG. 1, the controller 108 on the first peripheral device 104 allows the host 102 to access the first peripheral device 104 through a SATA port 120.

FIG. 2 is a block diagram of a second SATA bus architecture 200 having the first peripheral device 104 in addition to a second peripheral device 204 according to the prior art. The host 206 includes a first SATA port 203 and a second SATA port 202. In the second SATA bus architecture 200 shown in FIG. 2, the first peripheral device 104 is electrically connected to the host 206 using a first SATA cable 208 connected to the first SATA port 203, and the second peripheral device 204 is electrically connected to the host 206 using a second SATA cable 212 connected to the second SATA port 202. The first peripheral device 104 is an optical storage device such as that shown in FIG. 1 and includes the controller 108, the optical pick-up 110, the optical storage medium 112, and the buffer memory 114. The second peripheral device 204 is a flash card device and includes a controller 214, a flash card access device 216, and buffer memory 218. The controller 108 on the first peripheral device 104 communicates with the host 206 using the SATA port 120, and the controller 214 on the second peripheral device 204 communicates with the host 206 using a SATA port 220. In this way, the host 206 can access the optical storage and flash card storage devices using the SATA cables 208, 212, respectively.

Although it is possible to connect more than one peripheral device to a host using additional SATA cables as shown in FIG. 2, each additional peripheral device requires an additional SATA cable and two corresponding SATA ports. In some situations, the host may not have enough SATA ports to accommodate the number of peripheral devices.

FIG. 3 shows an example of a port multiplier 300 used to increase the number available SATA ports. A host port 302 of the port multiplier 300 is electrically connected to a free SATA port 304 on the host 102 using a SATA cable 306. The port multiplier 300 provides three device ports 308, 310, 312. Please note, port multipliers 300 may be designed having up to fifteen device ports. As an example, FIG. 3 shows that each device port 308, 310, 312 is connected to a SATA port 314, 316, 318 on three peripheral devices 320, 322, 324, respectively. In this way, the host 102 can access the three peripheral devices 320, 322, 324 from a single SATA port 304. Additionally, because the port multiplier is part of the SATA specification, no specialized software drivers are required in the host 102 to use the port multiplier 300 shown in FIG. 3. More information on the specific operation and use of port multiplexers 300 is described in “Serial ATA II: Port Multiplier Revision 1.1,” Rev 1.1, 9 Oct. 2003, which is also available on the Serial ATA working group website: www.serialata.org and is incorporated herein by reference.

There are several disadvantages with using separate SATA cables and or port multipliers as shown in FIG. 2 and FIG. 3 to increase the number of available SATA ports. Firstly, there may be a large amount of redundancy between each of the peripheral devices. For example, as shown in FIG. 2, the first peripheral device 104 and the second peripheral device 204 each include controllers 108, 214; buffer memory 114, 218; as well as other hardware (not shown) that could be shared among the attached peripheral devices. Additionally, the SATA ports 120, 220 each include SATA interface analog line-drivers to properly drive the SATA cables 208, 212 and are therefore relatively expensive. SATA cables connected between SATA ports also interfere with air movement and heat dissipation from the internal airspace of a system into which peripheral devices and a port multiplier are installed. While it is possible to implement the port multiplier 300 and a plurality of peripheral devices 320, 322, 324 as a single device, this does not solve the redundant hardware problem because SATA links are still required from the port multiplier to each of the peripheral devices. Therefore, each peripheral device requires its own controller and associated hardware. Additionally, each analog SATA interface port causes an increase in latency due to handshake operations performed according to the SATA specification.

### SUMMARY OF INVENTION

One objective of the claimed invention is therefore to provide an electronic apparatus having a plurality of peripheral devices accessed by a host through a SATA port, to solve the above-mentioned problems.

According to an exemplary embodiment of the claimed invention, an electronic apparatus is disclosed comprising a controller having a serial AT Attachment (SATA) port, and being electrically coupled to a host through the SATA port; and a plurality of peripheral devices electrically coupled to the controller using digital means; wherein the controller allows the host to access the peripheral devices through the SATA port.

According to another exemplary embodiment of the claimed invention, a method is disclosed for accessing an electronic apparatus. The method comprises providing a controller having a serial AT Attachment (SATA) port, and being electrically coupled to a host through the SATA port; electrically coupling a plurality of peripheral devices to the controller using digital means; and accessing the peripheral devices from the host through the SATA port.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a first SATA architecture 100 having a single peripheral device 104 according to the prior art.

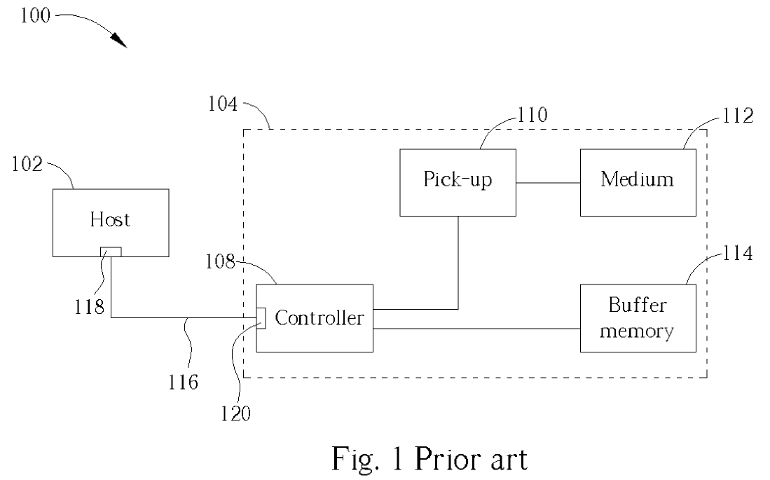

FIG. 2 is a block diagram of a second SATA bus architecture 200 having the first peripheral device 104 and a second peripheral device 204 according to the prior art.

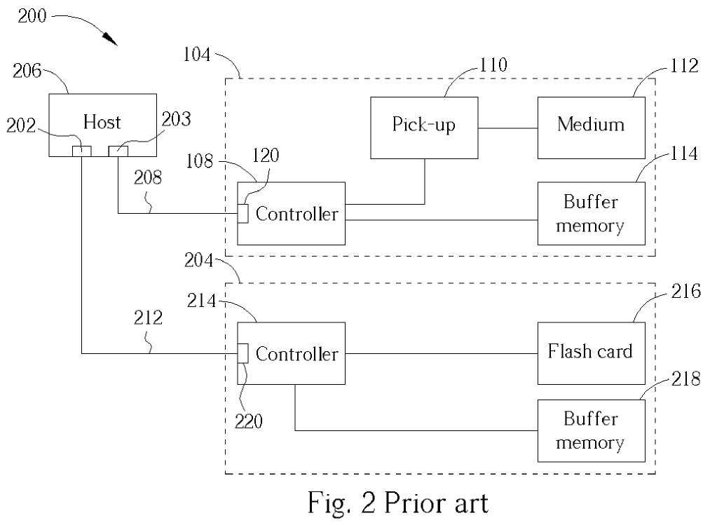

FIG. 3 shows an example of a port multiplier 300 used to increase the number available SATA ports.

FIG. 4 is an electronic apparatus 400 including a plurality of peripheral devices 402, 404, 406 accessible by a host 408 using a single SATA port 410 according to the present invention.

FIG. 5 is a more detailed block diagram of the controller 412 of FIG. 4.

FIG. 6 is a flowchart describing a general method for accessing an electronic apparatus from a serial AT Attachment (SATA) port according to the present invention.

### DETAILED DESCRIPTION

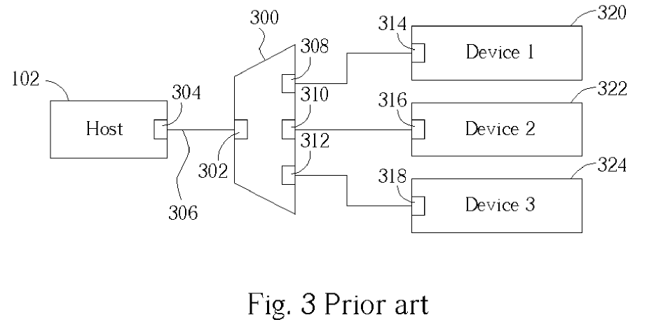

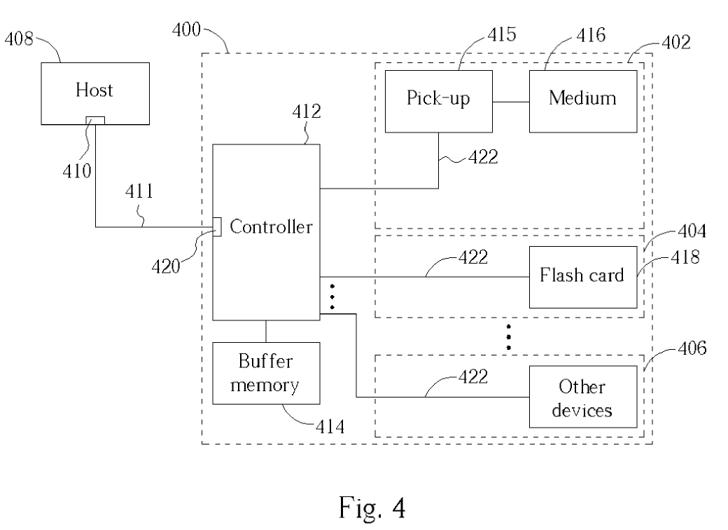

FIG. 4 is an electronic apparatus 400 including a plurality of peripheral devices 402, 404, 406 accessible by a host 408 using a single SATA port 410 according to the present invention. The electronic apparatus 400 includes a controller 412, buffer memory 414, and at least a first peripheral device 402 and a second peripheral device 404. In the example embodiment shown in FIG. 4, the first peripheral device 402 is an optical storage device and includes an optical pick-up 415, and an optical medium 416. The second peripheral device 404 is a flash card device and includes a flash card access device 418. Additionally, other peripheral devices 406 having other functions can be included. According to the present invention, up to fifteen peripheral devices can be included in the electronic apparatus 400. Each of the peripheral devices 402, 404, 406 is connected to the controller 412 using digital means 422. This digital means 422 can be implemented using a variety of different techniques well known to a person skilled in the art of circuit board or integrated circuit design. For example, the digital means 422 could be implemented using parallel address and data busses, serial links, or a combination of both. The present invention is not limited to a specific digital means but rather that the connection between the controller 412 and peripheral devices 402, 404, 408 is implemented using digital techniques and not using a SATA cable. A SATA port 420 on the controller 412 is electrically connected to the SATA port 410 of the host 408 using a SATA cable 411, and the host 408 accesses each of the peripheral devices 402, 404, 406 through the single SATA port 410. The controller 412 operates similar to a port multiplier, such as the port multiplier 300 shown in FIG. 3, however, instead of including analog SATA device ports 308, 310, 312, the controller 412 connects to the peripheral devices 402, 404, 406 using digital means 422. In this way, no additional SATA ports or SATA cables are required between the controller 412 and peripheral devices 402, 404, 406. Additionally, because port multiplier functionality is part of the SATA specification, no specialized software drivers are required in the host 412 to allow the host 412 to access the plurality of peripheral devices 402, 404, 406 using the single SATA port 410. On the host 410, other SATA ports (not shown) are thereby freed for use by other peripheral devices (not shown) having their own SATA ports.

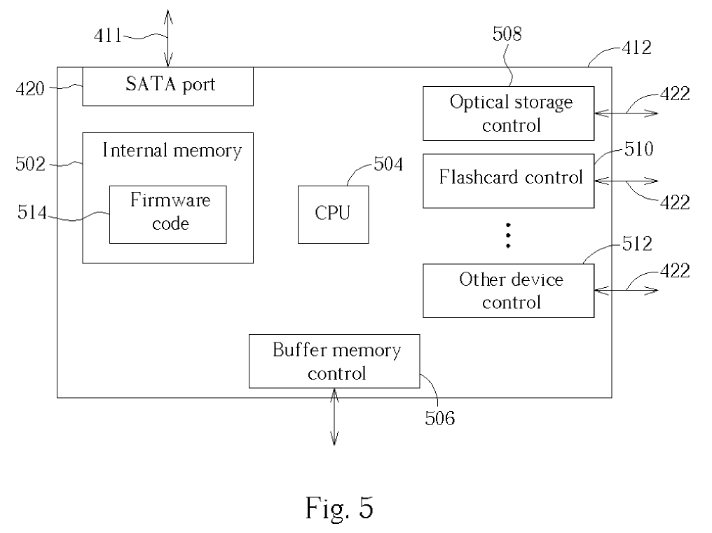

FIG. 5 is a more detailed block diagram of the controller 412 of FIG. 4. The controller 412 includes the SATA port 420, internal memory 502, a central processing unit (CPU) 504, a buffer memory control unit 506, an optical storage control unit 508, a flash card control unit 510, and other device control unit(s) 512. The SATA port 420 electrically couples the controller 412 to the SATA cable 411, which is coupled to the SATA port 410 on the host 408. The internal memory 502 is used by the CPU 504 as a temporary storage area and also includes program instructions corresponding to firmware code 514, which are executed by the CPU 504. It should be noted that the firmware code 514 could also be stored in external non-volatile memories (not shown) on or connected to the controller 412. The firmware code 514 contains instructions that allow the CPU 504 to operate as a port multiplier and communicate with the host 408 using the SATA port 420. The CPU 504 controls the first, second, third peripheral devices 402, 404, 406 according to commands from the host 408 using the optical storage control 508, flashcard control 510, or other device control 512, respectively, which are connected to the first, second, third peripheral devices 402, 404, 406 using the digital means 422.

There are several advantages of the present invention corresponding to the electronic apparatus 400 shown in FIG. 4 and the controller 412 shown in FIG. 4 and FIG. 5. Firstly, all the peripheral devices 402, 404, 406 connected to the controller 412 share both the controller 412 and the buffer memory 414. Because the controller 412 according to the present invention can have up to fifteen attached peripheral devices, this amounts to substantial savings in the number of controllers and amount of buffer memory needed in the electronic apparatus 400. Additionally, other hardware items (not shown) can similarly be shared among the peripheral devices connected to the controller 412 such as power supplies, clock/timing circuits, cache circuits, indicators, etc. Another advantage of the present invention is that by using direct memory access (DMA), data can be directly transferred from one peripheral device that is connected to the controller 412 to another peripheral device that is also connected to the controller 412. The data does not need to be sent across the SATA interface to be temporarily buffered in the host 408. Again, because the controller 412 according to the present invention can have up to fifteen attached peripheral devices, this greatly reduces workload of the host 408 and increases the overall efficiency of the operation of the electronic apparatus 400 and the host 408. Because the digital means 422 is used to connect the controller 412 and the attached peripheral devices, no SATA ports or SATA cables are required and the cost of the electronic apparatus 412 is therefore significantly reduced. The reduced number of SATA cables improves air movement and heat dissipation from the internal airspace of a system into which the electronic apparatus is installed. Furthermore, the digital means 422 can be designed to avoid complicated handshake operations between the controller 412 and the peripheral devices, which thereby improves latency and further increases the efficiency of the electronic apparatus 400.

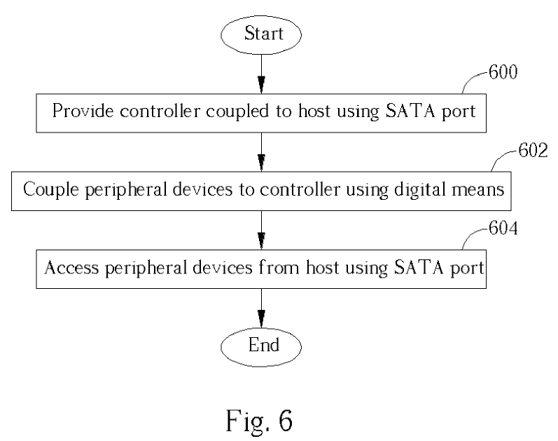

FIG. 6 is a flowchart describing a general method for accessing an electronic apparatus from a serial AT Attachment (SATA) port according to the present invention. The flowchart contains the following steps:

Step 600:Provide a controller in the electronic apparatus having a SATA port, the controller being electrically coupled to the host through the SATA port.

Step 602:Electrically couple a plurality of peripheral devices to the controller using digital means. The controller performs functions similar to a port multiplier, such as the port multiplier 300 shown in FIG. 3, however, instead of including analog SATA device ports, the controller uses the digital means to connect to the peripheral devices. In this way, no additional SATA ports or SATA cables are required between the controller and the peripheral devices.

Step 604: Access the peripheral devices from the host through the SATA port. Because port multiplier functionality is part of the SATA specification, no specialized software drivers are required in the host to allow the host to access the plurality of peripheral devices.

It is an advantage of the present invention that an additional step can also be added after Step 604, the additional step being: Directly transferring data from one peripheral device that is connected to the controller to another peripheral device that is also connected to the controller. Direct memory access (DMA) can be used to perform this transfer and will greatly reduce the workload of the host and increase the overall efficiency of the operation of the host and the electronic apparatus according to the present invention.

Those skilled in the art will readily observe that numerous modifications and alterations of the device may be made while retaining the teachings of the invention. Accordingly, the above disclosure should be construed as limited only by the metes and bounds of the appended claims.

1. An electronic apparatus comprising:
a controller having a serial AT Attachment (SATA) port, and being electrically coupled to a host through the SATA port; and
a plurality of peripheral devices electrically coupled to the controller using digital means;
wherein the controller allows the host to access the peripheral devices through the SATA port.

2. The electronic apparatus of claim 1, wherein the controller operates as a port multiplier to allow the host to access the peripheral devices through the SATA port.

3. The electronic apparatus of claim 1, wherein the peripheral devices electrically coupled to the controller at least comprise an optical storage device and a nonvolatile storage device.

4. The electronic apparatus of claim 3, wherein the nonvolatile storage device is a flashcard access device or a hard-disk drive.

5. The electronic apparatus of claim 1, wherein the peripheral devices include a first peripheral device and a second peripheral device, and the controller directly transfers data stored on the first peripheral device to the second peripheral device without buffering the data in the host.

6. A method of accessing an electronic apparatus, the method comprising:
providing a controller having a serial AT Attachment (SATA) port, and being electrically coupled to a host through the SATA port;
electrically coupling a plurality of peripheral devices to the controller using digital means; and
accessing the peripheral devices from the host through the SATA port.

7. The method of claim 6, furthering comprising operating the controller as a port multiplier to allow the host to access the peripheral devices through the SATA port.

8. The method of claim 6, wherein the peripheral devices electrically coupled to the controller at least comprise an optical storage device and a non-volatile storage device.

9. The method of claim 6, wherein the non-volatile storage device is a flashcard access device or a hard-disk drive.

10. The method of claim 6, wherein the peripheral devices include a first peripheral device and a second peripheral device, and the method further comprises directly transferring data stored on the first peripheral device to the second peripheral device without buffering the data in the host.
